(19) United States
(12) Patent Application Publication
(10) Pub. No.: US 2015/0173138 A1
(43) Pub. Date: Jun. 18, 2015

(54) A DEVICE AND SYTEM FOR LED LINEAR FLUORESCENT TUBE LAMP DRIVER

(71) Applicant: General Electric Company, Schenectady, NY (US)

(72) Inventor: Bruce Richard Roberts, Mentor-on-the-Lake, OH (US)

(73) Assignee: General Electric Company, Schenectady, NY (US)

(21) Appl. No.: 14/132,059

(22) Filed: Dec. 18, 2013

(51) Int. Cl. H05B 33/08

(52) U.S. Cl. CPC H05B 33/0812

(57) ABSTRACT

Provided is a circuit replacement device for a light emitting diode (LED) tube lamp. The circuit includes a cathode emulator configured for (i) coupling to an input power source and (ii) emulating operation of a fluorescent lamp cathode. Also included is a rectification mechanism having an input port coupled to an output of the cathode emulator and an output port configured for coupling to at least one from the group including a current supply and an output load.

### I. FIELD OF THE INVENTION

The present invention relates generally to replacement linear fluorescent tube lamps with light emitting diode (LED) drivers.

### II. BACKGROUND OF THE INVENTION

LEDs have rapidly increased in lighting applications due to their efficiency and lifetime sustainability over fluorescent lamps. LEDs are mercury free light sources, requiring a direct current (DC) voltage or current to operate optimally. Operating on a current controlled power supply enables LEDs to achieve high lumens per watt efficiency, constant color temperature, and high color rendering. Additionally, with a potential lifetime of 100,000 hours, LEDs virtually eliminate maintenance and replacement costs associated with linear fluorescent lights.

In a typical fluorescent tube lamp, a ballast is used to regulate the current flow through the tube lamp so that the current does not rise to a level that would destroy the lamp. As such, the type of ballast selected for a lighting application depends on the current flow needed to run through the ballast. For light emission to occur in a fluorescent tube lamp, the ballast creates a high voltage alternating current (AC) waveform to break down the conducting gas and start the electrical current flowing in the tube. This can be preceded by heating of the tube lamp's cathode in some designs in order to provide for less stress to the cathode when the high voltage is applied.

In an LED, a driver also regulates the current flow through the bulb but no high voltage is necessary for starting. Also, an LED does not contain a cathode to start the light emission process as in a fluorescent lamp. The driver circuitry (1) converts incoming low frequency AC voltage to the proper DC voltage and (2) regulates the current flowing, i.e., constant current (CC), through the LED during its operation to protect the LED from line-voltage fluctuations.

The CC power supply passes current over the driver circuitry of the LED causes light to be emitted from the diode. The brightness of the light emitted from the LED is a function of current flow. To emit light, an LED needs a minimum operating DC voltage and a regulated current. Voltage and current requirements vary greatly between LED manufacturers and can be arranged in series or parallel in order to obtain desired operating voltages and currents.

Despite their benefits, LEDs are used in limited applications in replacing linear fluorescent tubes because the output of a traditional fluorescent ballast is not compatible with an LED's operating requirements and most LED drivers would be damaged by the high voltage starting and are incompatible with the possible cathode heating if provided.

There have been multiple attempts to rectify the problems associated with replacing a fluorescent tube lamp driver with an LED driver. One solution has been to feed the AC connection directly to the linear fluorescent lamps (LFL) connectors (tombstones) and use a flyback topology. However this configuration is problematic in that the direct AC connection can lead to a safety hazard to the installer since the tombstones are not rated for AC line voltage. The second problem with this approach is if someone later removes the LED tube and replaces it with the original LFL, it may start and will destroy itself when connected directly to the AC line in this manner.

Another solution has been to add capacitors in series with AC pin connections instead of using a power supply. This direct solution is also problematic because it typically introduces a large degree of variance in power levels since this solution relies on the impedance value of the capacitor to regulate current. The output of high and low frequency ballast and even various high frequency ballasts would lead to extreme power variance.

### III. SUMMARY OF EMBODIMENTS OF THE INVENTION

Based on the aforementioned failures associated with driver replacement, there exists a need for an LED driver circuit that does not require the rewiring of a fixture when connected to a fluorescent tube lamp ballast. That is, a need exists for an LED driver circuit that can work with all ballast types, including instant start, rapid start and program stat fluorescent ballasts. Additionally, the LED replacement driver circuit will limit the possible high voltage normally provided by the LFL ballast. Embodiments of the present invention provide an LED replacement driver circuit comprising a cathode emulator, a voltage steering and rectifier, which allows the driver circuit to serve as a universal replacement driver circuit that is agnostic to the ballast structure.

One benefit of a universal replacement driver is it allows an LED driver to be installed in a fluorescent tube lamp ballast. The lighting industry has explored ways to replace the standard fluorescent light bulb with more energy efficient LEDs because of their efficiency and lifetime. The proposed driver replacement solution does not require any rewiring or other costly changes to the existing driver, thus it is beneficial to have an LED system that can be directly interchanged with a fluorescent system.

In one embodiment, the replacement driver circuit topology creates a cathode emulator that imitates the actions of a fluorescent lamp cathode, allowing the ballast to think that the replacement driver circuit operates the same was as a florescent lamp. The topology also simulates the correct impedance of a fluorescent lamp.

Another benefit of the universal replacement driver is the option for the driver to be internal to the LED tube. Allowing the driver to be internal eliminates the need to rewire fixtures based on ballast composition and allows for universal replacement of linear fluorescent lamps. It also protects the driver components from external forces which may affect the performance of the driver after it has been installed, such as human contact.

Another benefit of the universal replacement driver is it allows the driver to be directly connected to the power input connection pins of a ballast. Typically, connecting an LED replacement driver directly to the linear fluorescent ballast pin connections introduces too much voltage across the lamp driver. This direct connection, without the presence of a limiting circuit, can result in as much as 600V potential to ground, i.e. 1200V across the entire lamp, which is enough voltage to cause failure in most LED drivers.

In another embodiment, the replacement driver contains a switch mode converter to allow for use of the replacement driver in applications where a constant output current, and thus a constant light output, is desired. In this embodiment, the switch mode converter is paired with a cathode emulator, voltage and rectifier, power supply, and power supply controller.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### IV. BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of the universal replacement driver system.

FIG. 2 is an exemplary circuit diagram of the universal replacement driver in accordance with an exemplary embodiment of the present invention.

FIG. 3 is an exemplary circuit diagram of the universal replacement driver system in accordance with an exemplary embodiment of the present invention.

### V. DETAILED DESCRIPTION OF THE PREFERRED EMBODIMENTS

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

Unless defined otherwise, technical and scientific terms used herein have the same meaning as is commonly understood by one of ordinary skill in the art to which this invention belongs. The terms “first,” “second,” and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean either any, several, or all of the listed items. The use of “including,” “comprising,” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect. The terms “circuit,” “circuitry,” and “controller” may include either a single component or a plurality of components, which are either active and/or passive components and may be optionally connected or otherwise coupled together to provide the described function.

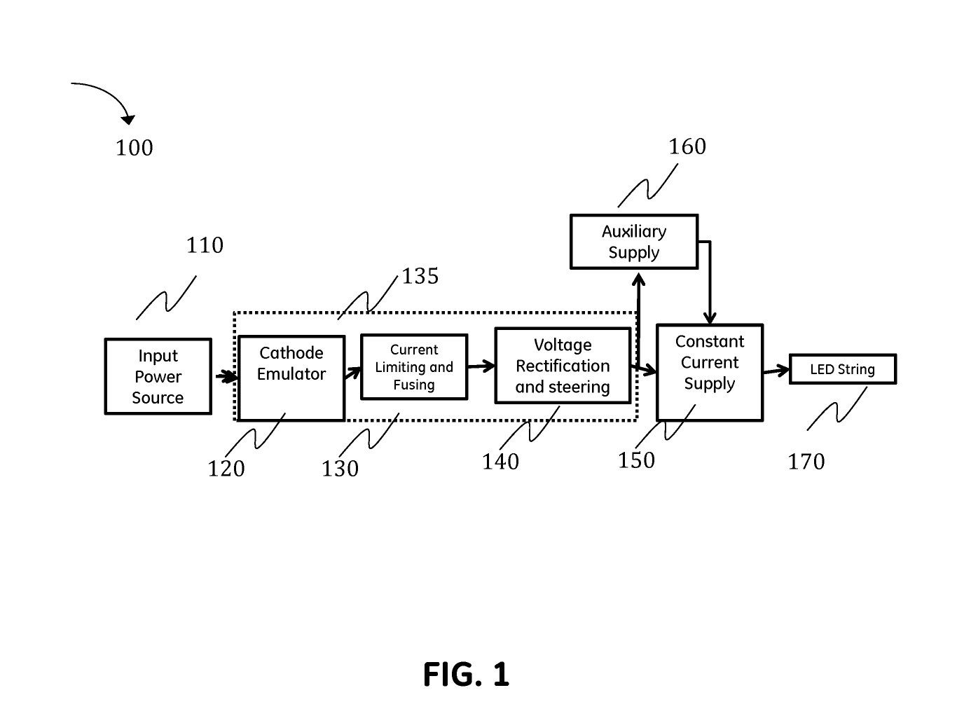

FIG. 1 is an illustration depicting a block diagram of a universal driver replacement system 100 in accordance with an exemplary embodiment of the present invention. The system 100 may be any replacement driver that universally operates between an LED load and fluorescent lamp ballasts. In some embodiments, the entire driver and LED are incorporated inside a tubular LED assembly from a complete universal linear fluorescent tube drop in solution. In some embodiments, the system 100 may be a replacement driver suitable for high power and high voltage applications.

As illustrated in FIG. 1, the driver replacement system 100 generally includes a power input 110, a replacement driver circuit 135, and a power output 175. In applications with direct connection to the AC mains, or where precise constant current is desired, a constant current power supply, typically a switched-mode power supply (SMPS) 150 is added. If this SMPS is added, it also requires an auxiliary supply 160 to be present.

The input power source 110 provides electrical power from a LFL ballast or from the AC mains if a constant current supply 150 is used in the design. Power input is normally delivered via a connector which may be multiple pronged pins or other devices with which to receive voltage from an external source.

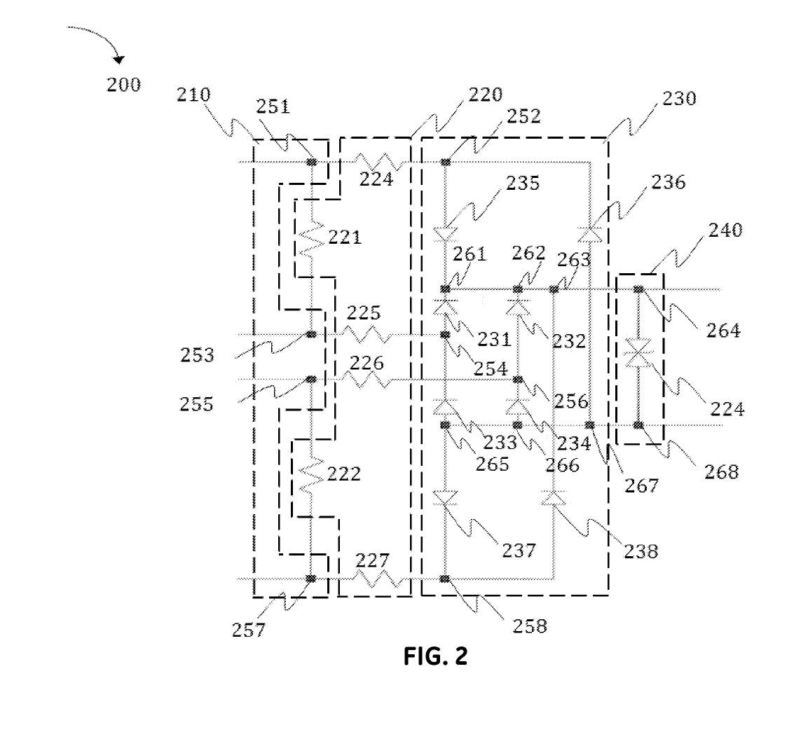

The replacement driver circuit 135 includes a cathode emulator 120, a current limiting and fusing mechanism 130, and voltage rectification and steering device 140. The voltage from the input power source 110 first passes through the cathode emulator 120, then through the current limiting and fusing 130, and the voltage steering and rectifier 140. When voltage passes through the components of the replacement driver circuit 135 in the aforementioned order, the circuit 135 can be used in LED applications to function similar to florescent linear circuits. Further details of each components of the replacement driver circuit 135 are discussed in FIG. 2 below.

In AC mains applications, it is necessary for replacement driver circuit 135 to include a constant current supply 150 (typically implemented as a SMPS). The purpose of the constant current supply 150 is to allow the voltage to be stepped up/down for the application to control the LED output power. When required. The constant current supply 150 can be accompanied with an auxiliary voltage power supply 160 to provide operating power for the current supply 150.

The power output is delivered to a string array of LEDs 170. The string array 170 can be multiple LEDs connected in series or parallel with a current-limiting circuit for each string. The number of LED strings, within string array 170, should be within the maximum voltage dictated by the driver as to not overload the replacement driver system 100 and to properly match the desired power available to the power desired for the LEDs. In one embodiment, the LED voltage string 170 is chosen to be 150V so that enough power is available from the LFL ballast since this is near their normal operating point when connected to a fluorescent lamp.

Although not illustrated in FIG. 1, in some embodiments, the system 100 may include one or more other devices and components. For example, there may exist a transistor link between the replacement driver circuit 135 and the current supply 150. Also, one or more filters may be added between the current supply 150 and the LED string 170.

FIG. 2 is an illustration depicting an exemplary replacement driver for use as a direct connection to a ballast. The replacement driver circuit 200 includes a power input connector 210, a cathode emulator 220, a voltage steering and rectification mechanism 230, and a voltage limiter 240. This circuit can be used in a standalone fashion without a constant current power supply if its input is a linear fluorescent ballast and its output is the appropriate voltage LED sting.

As shown in FIG. 2, the left side of replacement driver circuit 200 includes the power input connector 210, which is substantially similar to the power input connector 110 described in FIG. 1. As described above, a power input source is a voltage from an existing linear fluorescent ballast. The power input source provides electrical power to the power input connection points 212, 214, 216, and 218, which receives the incoming voltage. On the opposite end of the replacement driver circuit 200 is a positive power output 264 and a negative power output 268. The power output connection points deliver a rectified voltage from the circuit, to a load or switch mode converter.

After passing through the power input connection points, the next component of the replacement driver circuit 200 is the cathode emulator 220. The cathode emulator 220 is a portion of the replacement driver circuit 200 topology which simulates the conditions of cathode heating, as in a fluorescent lamp, to allow the ballast to switch from start mode to run mode. A typical fluorescent lamp is turned on with a high voltage provided by the ballast. Some ballasts attempt to provide cathode heating and will not transition from the high voltage start mode to the lower voltage operating mode unless they are successful in providing heat to the cathodes. The presence of the cathode emulator 220 also allows direct connection of the replacement driver 200 to the linear fluorescent ballast through power input connection points 251, 253, 255, and 257.

The cathode emulator 220 includes thermistors 221 and 222, each joining the power input connection point within the power input connector 210. Specifically, thermistor 221 joins together the two power input connection points 251 and 253 typically found at one end of a tubular fluorescent lamp. Similarly, thermistor 222 joins together the two power input connection points 255 and 257 typically found at the other end of a tubular fluorescent lamp.

Positive temperature coefficient (PTC) thermistors may be used within the cathode emulator 220 because their resistance rises suddenly at a predetermined critical temperature, i.e. curie point temperature. When power flows through a thermistor, it will generate heat which will raise the temperature of the thermistor above that of its environment. This increase in temperature is exploited in the present invention to simulate the heating of a cathode and then increase their resistance as a function of time and energy. This allows them to have an effect on the circuit when cold and effectively remove them from the circuit when they heat up.

The thermistors 221 and 222 can sustain temperatures well above and exemplary operating point of 100° C. They may also have a resistance rating, for example, from 7-15 ohms to successfully emulate a linear fluorescent cathode. For a linear relationship between temperature and resistance, the temperature coefficient (k) can be defined by:

$$k = \frac{1}{R ( T )} * \frac{d R}{d T}$$

where R is resistance in ohms and T is temperature in Kelvin. The relationship between temperature and resistance for non-linear relationships between temperature and resistance can be defined by:

$$\frac{1}{T} = A + B ln ( R ) + {C ( ln ( R ) )}^{3}$$

where A, B, and C are the Steinhart-Hart coefficients based on the manufacturing specifications of the particular type and model of the PTC thermistor.

The cathode emulator circuit 220 also contains fusible resistors (FR) 224, 225, 226, 227, each connected to a power input connection point. Fusible resistors are used in the cathode emulator 220 due to their inherently low resistance and their ability to receive large amounts of voltage and current. In a typical FR, when current passing through the resistor increases, the resistor emits heat which will in turn melt a solder which connects a spring to the resistor causing the spring to pop up and open the circuit.

When the circuit opens, it performs as a traditional fuse by safely and permanently removing power to the rest of the circuit. Although FRs are specifically mentioned, other devices, such as fuses which have the ability to open a circuit connection within the device, may also be used. FRs 224, 225, 226, and 227 have a resistance that is substantially lower than thermistors 221 and 222. In the normal operating state, the resistors have a resistance approximately between 1-5 ohms. This provide a voltage drop when over voltage protection device 224 is activated, typically during the initial ballast start phase.

The next component of the replacement driver circuit 200 is the voltage rectification and steering mechanism 230. The voltage rectifier and steering mechanism 230 is a plurality of diodes including eight unidirectional diodes 231 through 238. In one embodiment, the replacement circuit driver 200 uses a full waveform rectification causing a need for each input connection point 251, 253, 255, and 257 to have both a diode that conducts on the positive line and a corresponding diode that conducts on the negative line. The diodes 231 through 238 are each located on a plurality of transverse arrays which connect the input power connections 251, 253, 255, and 257 to the output power connections 264 and 268. Normally, input rectification is accomplished with four diodes, but eight are desirable in this embodiment since two of the four possible input connections 251, 253, 255, or 257, which will be applying the input power, are unknown.

Also included in the replacement driver circuit 200 is the voltage limiting circuit 240 which contains a voltage limiting device 224. Voltage limiter 224 provides protection to the LEDs or other circuits that are subsequently connected to the output connection 264 and 268 from receiving damaging high voltage transients during initial startup of the fluorescent ballast output. In the embodiment, a 550V transorb can be utilized to ensure safe and reliable operation with a linear fluorescent ballast system. Therefore, the voltage limiter 240, in conjunction with the voltage rectifier and steering mechanism 230, transforms the initial AC voltage waveform into a rectified DC waveform, which passes to positive power output 264 and negative power output 268.

The voltage limiter 224 can be implemented as many types of clamping diodes or circuits such as, Zener diodes, gas discharge tubes, transient voltage suppressors, or similar devices which prevent over voltage operation.

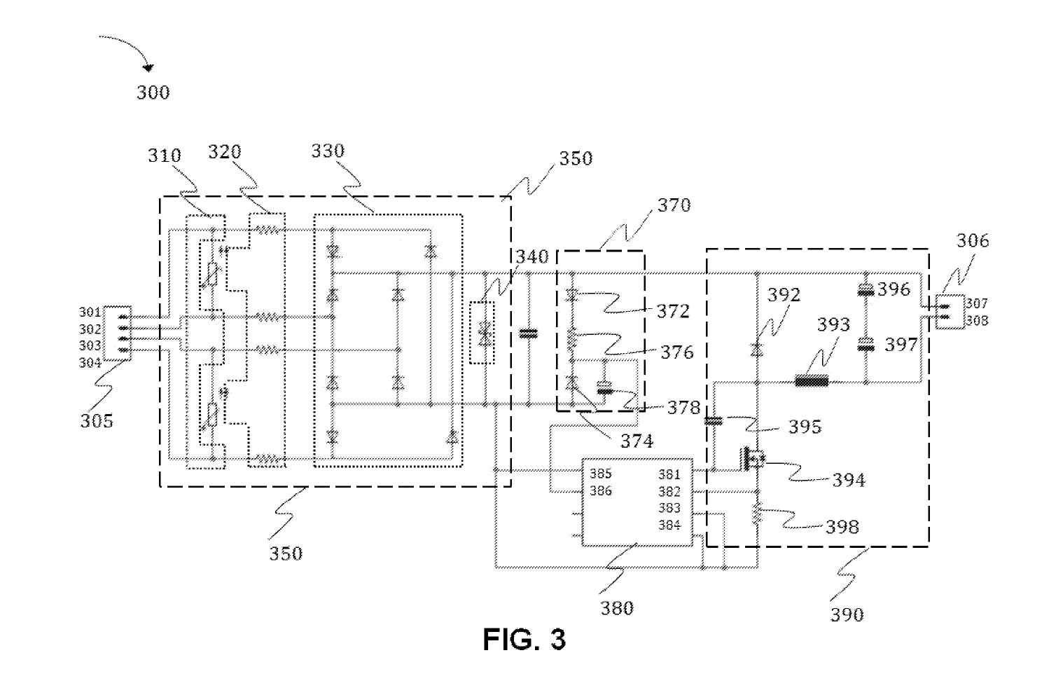

FIG. 3 is an illustration of an exemplary replacement system 300 in accordance with the embodiments. This embodiment includes a constant current supply and can be used on either a fluorescent ballast or connected directly to the AC mains voltage. The universal replacement driver system 300 includes, among other components, a power input connector 305, which passes through the previously described (FIG. 2) replacement driver 350, and a current limiting switch mode converter 390 before going to a power output connector 306.

The power input connector 305 has power input connections 301, 302, 303, and 304. The power input connection points 301, 302, 303, and 304 are substantially similar to the power input connections 251, 253, 255, and 257 as described in FIG. 2. The power input source 305 can be an AC voltage input either from direct connection to AC mains voltage or connection to a linear fluorescent ballast. The power output connector 306 includes power output connection points 307 and 308. The power output connector 306 delivers the voltage and current to an internal or external LED string 170, illustrated in FIG. 1.

The replacement driver system 300 also includes replacement driver circuit 350. The circuit 350 consists of the power input connector 310, the cathode emulator and FRs 320, voltage rectification and steering 330, and voltage clamp 340. The aforementioned components of replacement driver circuit 350 are substantially similar to the power input connector 210, the cathode emulator and fusible resistors 220, voltage rectification and steering 230, and voltage limiter (i.e., clamp) 240 in replacement driver circuit 200 as described above in FIG. 2. As such, a discussion of the specifics of each replacement driver circuit component will not be repeated.

The constant current switch mode converter 390 transfers power from an input source, i.e., power input connector 305, to a load, i.e., power output connector 306, while converting voltage and current. A switch mode power supply, such switch mode converter 390, is used in applications where the input voltage is different than the required output voltage, e.g., the AC input has a voltage that is higher or lower than the voltage required by LED output load. The switch mode converter 390 is typically accompanied with a voltage power supply 370 to sustain the function of the switch mode converter 390.

This embodiment of a switch mode converter 390 has primary components, specifically a diode 392, an inductor 393, and a transistor 394. The diode 392 allows the current to flow in a specific direction. Specifically in the embodiment, the current flows in direction of the power output connection 307. The diode 392 can be any type diode, field effect transistor (FET), or the like. The inductor 393 prevents instantaneous changes in current when the system 300 is in an open position, i.e., an off-state, giving the switch mode converter 390 a steady output current.

Inductor 393 can be wire-wound, planar, flat coil, power beads, drums, toroids, or the like. The transistor 394 starts and stops the flow of a current, as well as control the amount of the current flowing through switch mode converter 390. The transistor 394 can include any power semiconductors such as a bipolar junction transistor (BJT) for lower frequency applications or a metal oxide semiconductor field effect transistor (MOSFET) for higher frequency applications. Transistor 394 can also be an insulated gate bipolar transistor (IGBT) or the like.

Additionally, the switch mode converter 390 has secondary components that are necessary for the operation of the switch mode converter 390. The switch mode converter is operated by a controller integrated circuit 380. The feedback from the output is obtained from resistor 398 and capacitor 395, in this exemplary embodiment as current sense and zero crossing detectors. The resistor 376 is a current sense resistor that determines when the controller 370 should turn off the control signal to the transistor 394. The capacitor helps the controller determine the zero crossing of the ringing of the switching node so that efficient turn on of the transistor 394 may occur.

Once maximum current has been detected by the current through resistor 398, the controller 380 terminates its signal to the transistor 394. After the signal is terminated to transistor 394, the voltage across capacitor 395 will rise. Once the capacitor 395 rings and its voltage has a value of zero, the controller 380 due to its connection with capacitor 395 and transistor 394, begins sending signals back to transistor 394 to again turn on.

Switch mode converter 390 is powered by auxiliary power supply 370. In one embodiment, the power supply 370 is a linear regulator operated from the rectified voltage. Other more efficient but more expensive options such as a separate switch mode power supply may also be utilized as this auxiliary supply circuit.

In the exemplary embodiments, the controller 380 measures voltage across switch mode capacitor 395 through controller connection 381, which regulates turning on of the transistor 394. The controller 380 also has connections directly to transistor 394 through connection 382 and to current sense resistor 398 through connection 383, which regulates the turning off the transistor 394 once peak current has been detected.

Switch mode converter 390 has a power supply 370 that includes diode 372, Zener diode 374, a resistor 376, and a capacitor 378. While in operation, the power supply diode 372 steers voltage from transistor link 360 towards the controller 380 and diode 374 limits the voltage from the controller 370 towards the controller 380. The operation of the power supply 370 is a simple linear regulator where diode 372 accepts only positive inputs, resistor 376 drops the excessive voltage and acts a current limiter, Zener 374 regulates the voltage and capacitor 378 store and energy and filters the output.

The switch mode converter 390 includes capacitors 396, 397 for smoothing the current provided by switch mode power supply 390 to the LED string connected to Pins 307 and 308.

In the exemplary switch mode converter 390, the output voltage is desirably lower than the input voltage, such as in a buck, a low side buck, a buck-boost converter, an isolated flyback, or the like. In other embodiments, a high voltage output is possible, though not preferred.

A buck topology allows a converter to step down voltage. In one embodiment, while in the on-state, i.e., the switch is closed, the input voltage circuit 350 is applied to the inductor 393, causing the inductor 393 current build up, and power is delivered to the power output source 306. While in the off-state, i.e., the switch is open, voltage across the inductor 393 reverses and the diode 392 becomes forward biased, which allows the energy stored in the inductor 393 to be delivered to the power output source. This output current is then smoothed by the output capacitors 396 and 397.

It is understood by one of skill in the art that that system 300 may include one or more other devices and components. For example, components included in power source 370 may differ in varying embodiments. Also, components of switch mode converter 390 may include different component types and quantities in varying topologies and embodiments.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What we claim is:

1. A circuit replacement device for a light emitting diode (LED) tube lamp, comprising:
a cathode emulator configured for (i) coupling to an input power source and (ii) emulating operation of a fluorescent lamp cathode; and
a rectification mechanism having an input port coupled to an output of the cathode emulator and an output port configured for coupling to at least one from the group including a current supply and an output load.

2. The device of claim 1, wherein the cathode emulator includes positive and negative input power source nodes; and
wherein the cathode emulator includes a first thermistor connected to the positive input power source node, a second thermistor connecting the negative input power source node, a first resistor connected to the positive input power source node, and a second resistor connected to the negative input power source node.

3. The device of claim 2, wherein the rectification mechanism is a voltage rectifier.

4. The device of claim 3, wherein the voltage rectifier includes a voltage rectifier and steering mechanism coupled to a voltage limiter.

5. The device of claim 4, wherein the voltage rectifier is positioned to receive power from the cathode emulator, the voltage rectifier including a first diode and a second diode; and
wherein the first and second diodes are configured to receive a voltage signal from the cathode emulator and direct the voltage signal to the positive output power source node.

6. The device of claim 5, wherein the voltage rectifier further comprises a third diode and a fourth diode located on a second array that is transverse to and in between the first and second power input source connection lines and the first and second power output source connection lines, the third and fourth diodes positioned to received voltage from the negative power output source and direct it to the cathode emulator.

7. The device of claim 6, wherein the first thermistor is connected to the positive power input source node via a connection line that is transverse to the input power source and the second thermistor is connected to the negative input power source node through a connection line that is transverse to the negative input power source.

8. The device of claim 7, wherein the cathode emulator further comprises a plurality of resistors, each connected to a positive input power source node or a negative input power source node.

9. The device of claim 4, wherein the voltage rectifier mechanism further comprises a third diode and a fourth diode located on a second array that is transverse to and in between first and second input power source connection lines and first and second power output source connection lines, the third and fourth diodes positioned to receive a signal voltage from the negative power output source and direct it to the cathode emulator.

10. The device of claim 9, wherein the voltage rectifier mechanism further comprises a plurality of transverse arrays, each array containing at least one diode positioned to direct voltage away from the cathode emulator to the positive power output source or at least one diode to direct voltage towards the cathode emulator from the negative power output source.

11. A circuit replacement device for a light emitting diode (LED) tube lamp, comprising:
a cathode emulator configured for (i) coupling to an input power source and (ii) emulating operation of a fluorescent lamp cathode;
a voltage rectifier having an input port coupled to an output of the cathode emulator and an output port configured for coupling to at least one from the group including a current supply and an output load; and
a voltage limiter coupled to an output of the voltage rectifier.

12. The device of claim 11, wherein the voltage rectifier includes a steering mechanism.

13. The device of claim 12, wherein the voltage rectifier is positioned to receive power from the cathode emulator, the voltage rectifier including a first diode and a second diode; and
wherein the first and second diodes are configured to receive a voltage signal from the cathode emulator and direct the voltage signal to the positive output power source node.

14. A method for starting a light emitting diode (LED) tube lamp, the lamp being configured to receive a voltage signal from a linear fluorescent ballast, the method comprising:
emulating, via a cathode emulator, operation of a fluorescent lamp cathode when the voltage signal is received;
wherein the emulating includes simulating an impedance of a fluorescent lamp cathode; and
wherein the emulating switches the fluorescent ballast from start mode to run mode; and
rectifying the received voltage signal to produce a rectified output waveform.

15. The method of claim 14, further comprising providing the rectified output waveform to an output load.

16. The method of claim 15, wherein the received voltage signal is an alternating current (AC) voltage signal; and
wherein the rectified output waveform is a direct current (DC) signal.

17. The method of claim 16, wherein the output load includes one or more light emitting diodes (LEDs).
